(19) United States
(12) Patent Application Publication
(10) Pub. No.: US 2017/0110998 A1
(43) Pub. Date: Apr. 20, 2017

(54) MOTOR DRIVING CONTROL APPARATUS

(71) Applicants: MICROSPACE CORPORATION, Tokyo (JP); TAIYO YUDEN CO., LTD., Tokyo (JP)

(72) Inventors: Masato TANAKA, Tokyo (JP); Hiromi Hagiwara, Tokyo (JP); Kazuo Asanuma, Tokyo (JP); Hirokazu Shirakawa, Tokyo (JP)

(73) Assignees: MICROSPACE CORPORATIOIN, Tokyo (JP); TAIYO YUDEN CO., LTD., Tokyo (JP)

(21) Appl. No.: 15/393,924

(22) Filed: Dec. 29, 2016

Related U.S. Application Data
(63) Continuation of application No. PCT/JP2015/068762, filed on Jun. 30, 2015.

(30) Foreign Application Priority Data
Jun. 30, 2014 (JP) 2014-135463

(51) Int. Cl. H02P 23/00; B62M 6/90; B62M 6/75; B62M 6/50; H02P 27/08; H02P 6/08

(52) U.S. Cl. CPC H02P 23/0027; H02P 27/08; H02P 6/08; B62M 6/75; B62M 6/50; B62M 6/90; B60Y 2200/91; B60Y 2200/13; B60Y 2400/602; B60L 2220/16; B60L 2200/12

(57) ABSTRACT

A driving control apparatus includes a controller that generates a first signal for controlling turn-on to a brushless motor, a PWM signal generator that generates a PWM signal for driving the brushless motor by continuous turn-on with a sine wave, and an inverter that supplies a driving voltage generated based on the first signal and the PWM signal for the brushless motor. The controller generates the first signal so that a turn-on section represented by the first signal continuously increases from a reference turn-on angle according to increase of a rotation speed, and the turn-on section having an angle corresponding to the continuous turn-on is kept when the rotation speed is equal to or greater than a predetermined speed. The PWM signal generator outputs the PWM signal in a range including a rotation speed at which the turn-on section begins to increase from the reference turn-on angle and more.

### CROSS-REFERENCE TO RELATED APPLICATIONS

This application is a continuing application, filed under 35 U.S.C. section 111(a), of International Application PCT/JP2015/068762, which was filed on Jun. 30, 2015 and claimed the benefit of priority of the prior Japanese Patent Application No. 2014-135463 filed on Jun. 30, 2014, the entire contents of which are incorporated herein by reference.

### TECHNICAL FIELD

This invention relates to a motor driving control apparatus for controlling driving of a motor, particularly to a motor driving control apparatus for controlling driving of a three-phase brushless motor.

### BACKGROUND TECHNOLOGY

As a driving method for driving a brushless motor, a driving method by intermittent turn-on and a driving method by continuous turn-on are known.

In the driving method by intermittent turn-on, a turn-on stop section in which the turn-on is stopped is provided for each phase, and because the phase current is switched in this turn-on stop section, there is a merit that the efficiency is not deteriorated even if strict lead angle control is not performed. In addition, because a square wave is frequently used as a driving voltage waveform applied to the motor, it is possible to make a circuit to generate driving signals relatively simple. Because of such merits, the driving method by intermittent turn-on is broadly used for a commercial 3-phase brushless motor, and a 120-degree turn-on driving method in which the turn-on degree is 120 degrees is frequently used, especially.

On the other hand, in the driving method by continuous turn-on, because the driving control is performed by a driving signal that has a continuous waveform such as a sine wave, there is a merit that the torque fluctuation is less than that of the driving method by intermittent turn-on, and it is possible to suppress occurrence of the vibration and/or noises, as a result. Moreover, when the driving voltage in the sine waveform is used, it is possible to obtain high efficiency by synchronizing the phase of the induced voltage with the phase of the phase current by appropriate lead angle control, because the waveform of the induced voltage is similar to that of the phase current.

However, the lead angle control in the driving method by continuous turn-on is typically performed based on positions of magnetic poles, which are predicted from output signals of sensors (typically, hall effect sensors) or the voltage waveform and current waveform, which are measured by a voltage and current detector, which is provided in advance, to measure the voltage waveform and current waveform of a coil terminal for each phase in the motor. Even in either of them, it is impossible or extremely difficult to predict the positions of the magnetic poles in a low rotation state immediately after the rotation start of the motor. Accordingly, the appropriate lead angle control cannot be realized. When the appropriate lead angle control is not performed in the driving method by continuous turn-on, the phase of the induced voltage is deviated from the phase of the phase current. In such a case, because there is no turn-on stop section in the driving method by continuous turn-on, the efficiency is rapidly deteriorated because the phase of the induced voltage becomes opposite to the phase of the phase current.

Thus, in a transient state in which the rotation speed and/or torque of the motor are largely changed and the prediction of the magnetic poles is difficult, the high efficiency that is a merit of the driving method by continuous turn-on is not realized and the efficiency is rather deteriorated than the driving method by intermittent turn-on. In order to cope with such a problem, a technique is proposed in which, in transient state such as the low rotation state of the motor, the driving is performed in the driving method by intermittent turn-on, and when the rotation speed of the motor exceeds a predetermined speed and the rotation becomes a steady state, the driving method is shifted to the driving method by continuous turn-on. For example, in Japanese Laid-open Patent Application Publication 2001-245487 (Patent Document 1), a method is disclosed in which the driving signal by intermittent turn-on and the driving signal by continuous turn-on are switched according to presence or absence of a disturbance such as a rapid change of the rotation speed.

### PRIOR TECHNICAL DOCUMENTS

Patent Document 1: Japanese Laid-open Patent Application Publication 2001-245487

However, in the conventional switching control from the driving method by intermittent turn-on to the driving method by continuous turn-on, there is a problem that the vibration and/or noises easily occur, because the torque of the motor changes suddenly when shifting from the driving method by intermittent turn-on to the driving method by continuous turn-on.

Namely, there is no conventional motor driving control apparatus that can suppress the occurrence of the vibration and/or noises when switching between the driving method by intermittent turn-on and the driving method by continuous turn-on.

### SUMMARY OF THE INVENTION

A motor driving control apparatus for driving a brushless motor in one embodiment includes: a turn-on controller configured to generate a first signal for controlling turn-on to the brushless motor; a Pulse Width Modulation (PWM) signal generator configured to generate a PWM signal for driving the brushless motor by continuous turn-on with a sine wave; and an inverter circuit configured to supply a driving voltage generated based on the first signal and the PWM signal for the brushless motor. The turn-on controller is configured to generate the first signal so that a turn-on section represented by the first signal continuously increases from a reference turn-on angle that is less than 180 degrees in accordance with increase of a rotation speed of the brushless motor, and the turn-on section of an angle corresponding to the continuous turn-on is kept when the rotation speed is equal to or greater than a predetermined speed, and the PWM signal generator is configured to output the PWM signal in a rotation speed range including a rotation speed at which the turn-on section begins to increase from the reference turn-on angle and more.

A motor driving control apparatus for driving a brushless motor in another embodiment includes: a turn-on controller configured to generate a first signal for controlling turn-on to the brushless motor; a Pulse Width Modulation (PWM) signal generator configured to generate a PWM signal for driving the brushless motor; and an inverter circuit configured to supply a driving voltage generated based on the first signal and the PWM signal for the brushless motor. The turn-on controller is configured to generate the first signal so that a turn-on section represented by the first signal continuously increases from a reference turn-on angle that is less than 180 degrees in accordance with increase of a rotation speed of the brushless motor, and the turn-on section of an angle corresponding to the continuous turn-on is kept when the rotation speed is equal to or greater than a predetermined speed. The PWM signal generator includes: a first generator configured to generate a first waveform for driving the brushless motor by continuous turn-on with a sine wave; a waveform mixer configured to generate a driving waveform by mixing a direct current waveform having a constant level for intermittent turn-on driving with a rectangular wave and the first waveform with mixing ratios that correspond to the rotation speed; and a second generator configured to generate the PWM signal based on the driving waveform. The waveform mixer is configured to increase the mixing ratio of the first waveform when the rotation speed increases, and is further configured to set 100% as the mixing ratio of the first waveform when the rotation speed is equal to or greater than the predetermined speed.

### BRIEF DESCRIPTION OF THE DRAWINGS

FIG. 1 is a diagram roughly depicting a motor-assisted bicycle relating to one embodiment of this invention;

FIG. 2 is a functional block diagram of a motor driving control apparatus relating to one embodiment of this invention;

FIG. 3 is a diagram depicting timing charts for hall output signals, turn-on angle control signals, monostable multivibrator output signals and expanded turn-on angle control signals (V_On signal) for V phase in one embodiment of this invention;

FIG. 4 is a diagram depicting PWM signals and voltage waveforms in one embodiment of this invention;

FIG. 5 is a diagram depicting the PWM signals for the V phase in one embodiment of this invention;

FIG. 6 is a functional block diagram of a turn-on angle expansion width determination unit in one embodiment of this invention;

FIG. 7 is a diagram depicting an example of a turn-on angle expansion function in one embodiment of this invention;

FIG. 8 is a diagram depicting timing charts for the hall output signals, a lower phase interpolation signal, a triangular wave and comparator output signals in one embodiment of this invention;

FIG. 9 is a diagram depicting timing charts for the hall output signals, the turn-on angle control signals, the comparator output signals and the expanded turn-on angle control signals (V_On signal) for the V phase in one embodiment of this invention;

FIG. 10 is a diagram depicting timing charts for the comparator output signals and voltage waveforms of respective phases in one embodiment of this invention;

FIG. 11 is a functional block diagram of a driving signal generator in one embodiment of this invention;

FIG. 12 is a diagram depicting an example of a waveform shifting function in one embodiment of this invention; and

FIG. 13 is a diagram depicting an example of a star connection of motor coils.

### DESCRIPTION OF EMBODIMENTS

Various embodiments of this invention will be explained properly referring to drawings, thereinafter. In addition, the same reference symbol is attached to the same element in the drawings.

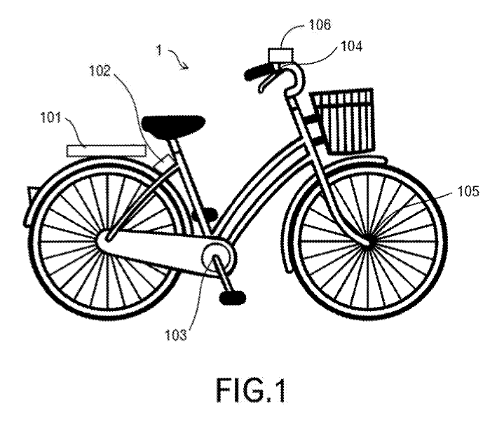

FIG. 1 roughly depicts a motor-assisted bicycle to which the motor driving control apparatus relating to one embodiment of this invention is applicable. The motor-assisted bicycle is desirable to be driven by the driving method by intermittent turn-on during stopping or low-speed running, because the assist by a large torque is required during the stopping or low-speed running. On the other hand, because the driving with high efficiency is desired after the speed reaches a predetermined speed, it is desirable to switch from the driving method by intermittent turn-on to the driving method by continuous turn-on. The motor driving control apparatus of this embodiment make it possible to smoothly shift from the driving method by intermittent turn-on to the driving method by continuous turn-on. Thus, it is possible to suppress the vibration and/or noises, which occurs in a conventional method when shifting from the driving method by intermittent turn-on to the driving method by continuous turn-on. Accordingly, the motor driving control apparatus of this embodiment is suitable for application to the motor-assisted bicycle. However, the motor-assisted bicycle is a mere example of application of the motor driving control apparatus relating to this invention, and the motor driving control apparatus relating to this embodiment can be employed for the driving control of the brushless motor in various purposes.

As depicted in FIG. 1, the motor-assisted bicycle 1 is a typical rear-driven type of bake whose crankshaft is connected to a rear wheel through a chain, and has a secondary battery 101, a motor driving control apparatus 102, a torque sensor 103, a brake sensor 104, a motor 105 and a control panel 106.

As for the secondary battery 101, various secondary batteries can be used such as a lithium ion secondary battery, a lithium ion polymer secondary battery, or a nickel-metal hydride chargeable battery. In one embodiment of this invention, the secondary battery 101 is a lithium ion secondary battery with a maximum supply voltage of 24 V (when fully charged).

The torque sensor 103 is provided on a wheel, which is installed in the crankshaft. The torque sensor 103 detects a pedal force or pressure, and outputs this detection result to the motor driving control apparatus 102.

The brake sensor 104 is composed of a magnet (not depicted) and a well-known reed switch (not depicted). The magnet is fixed to a brake wire (not depicted) coupled with a brake lever in a housing in which the brake lever is fixed and through which the brake wire passes. The brake lever is configured so as to cause the reed switch to be an ON state when the brake lever is grasped by the hand. In addition, the reed switch is fixed in the housing. An electrical connection signal of this reed switch is transmitted to the motor driving control apparatus 102.

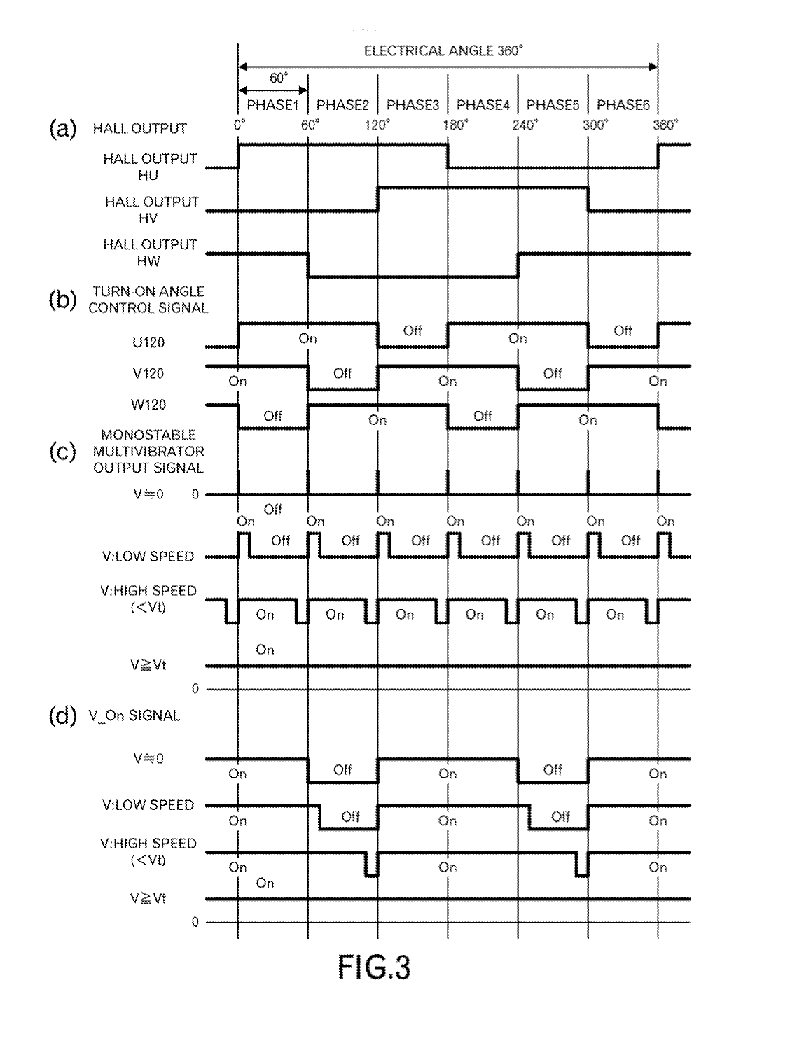

The motor 105 is, for example, a well-known three-phase direct current brushless motor. The motor 105 is mounted on a front wheel of the motor-assisted bicycle 1, for example. The motor 105 rotates the front wheel, and is coupled to the front wheel so that an internal rotor rotates according to the rotation of the front wheel. In addition, the motor 105 has plural (typically, three) hall effect elements (not depicted) in order to detect positions (i.e. phase of the rotor) of a magnetic pole, which the internal rotor has. A signal (i.e. hall output signal) that represents a phase of the rotor, which is detected by the hall effect element, is outputted to the motor driving control apparatus 102. When the number of hall effect elements is 3, these three hall effect elements are arranged in the motor 105 at regular intervals of 120 degrees of the electrical angle, for example, along a circumference direction. When the rotor of the motor 105 rotates, the hall effect elements detect a magnetic field caused by a permanent magnet of the rotor, and output the hall output signals Hᵤ, Hᵥ and H_{w} (See (a) in FIG. 3) according to the detected magnetic field intensity. In one embodiment of this invention, the motor-assisted bicycle 1 may have a current and voltage waveform detector 107 for measuring a voltage waveform and a current waveform of a coil terminal for each phase in the motor 105, depending on a phase detection method of the sine wave driving method. The current and voltage waveform detector 107 can supply the voltage waveform and the current waveform (or either of them) to a phase detector 118.

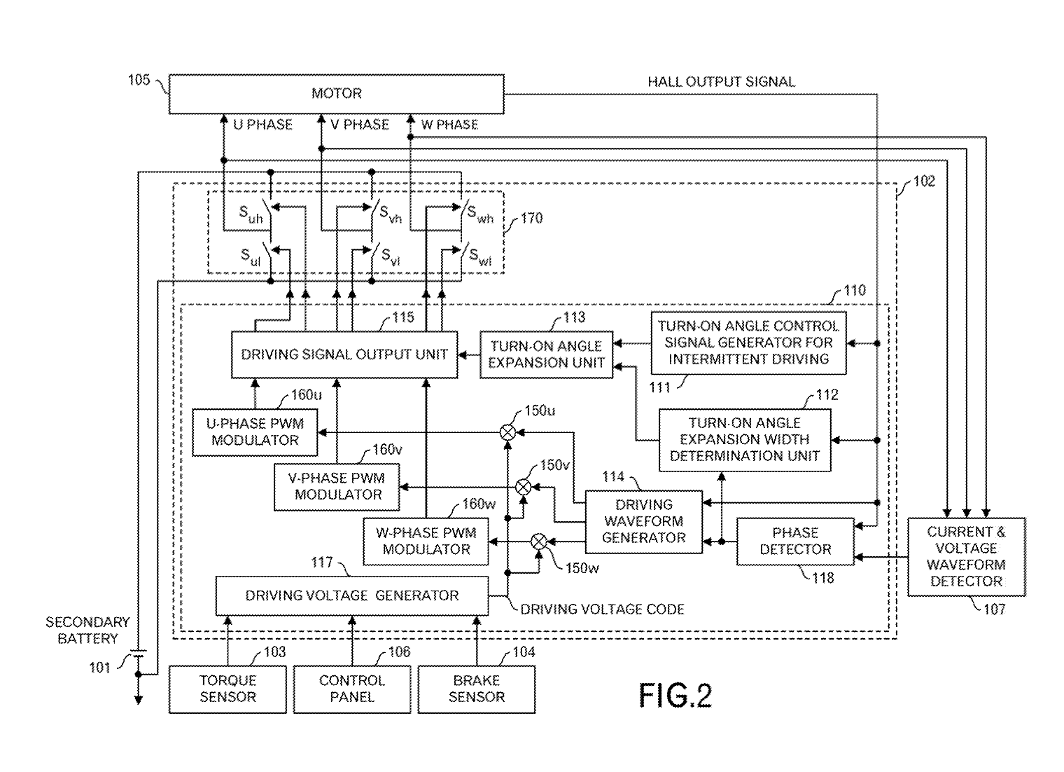

The motor driving control apparatus 102 for controlling the driving of the motor 105 is roughly depicted in FIG. 2. The motor driving control apparatus 102 relating to one embodiment of this invention drives the motor 105 by the driving method by intermittent turn-on during stopping and low-speed running of the motor-assisted bicycle 1, and is configured so as to gradually increase a turn-on angle when the vehicle speed of the motor-assisted bicycle 1 increases (reversely, gradually narrow an OFF section of the turn-on for each phase while the vehicle speed of the motor-assisted bicycle 1 increases) and drive the motor 105 with the turn-on angle of 180 degrees when the vehicle speed of the motor-assisted bicycle 1 is greater than a predetermined speed Vt (hereinafter, may be referred to “continuous turn-on shifting speed Vt”) (in other words, to drive the motor 105 with the driving method by continuous turn-on in a state where there is no OFF section of the turn-on). This speed Vt is a speed of the motor-assisted bicycle 1 when hall output signals by which the position of the magnetic pole can be predicted with sufficient accuracy for the driving method by continuous turn-on can be obtained, and, for example, is about 0.2 km/h to several km/h, and is about 0.5 km/h, preferably. In addition, the frequency (hereinafter, may be referred to “the continuous turn-on shifting frequency ft” in this specification) of the driving voltage of the motor 105 when the speed of the motor-assisted bicycle 1 reaches the continuous turn-on shifting speed Vt can be determined based on the continuous turn-on shifting speed Vt and a reduction ratio of the motor 105.

As depicted in FIG. 2, the motor driving control apparatus 102 has a driving controller 110 and an inverter circuit 170 that is composed of an FET (Field Effect Transistor) bridge. The FET bridge includes a high side FET (Sᵤₕ) and a low side FET (Sᵤₗ) to perform switching of the U phase of the 3-phase brushless motor 105, a high side FET (Sᵥₕ) and a low side FET (Sᵥₗ) to perform switching of the V phase of the motor 105, and a high side FET (S_{wh}) and a low side FET (Sᵥₗ) to perform switching of the W phase of the motor 105, and is configured by connecting the respective FETs so as to make a three-phase bridge. Each FET provided in the inverter circuit 170 is driven by a driving signal outputted from a driving signal output unit 115 (described later) of the driving controller 110. This driving signal is a PWM driving signal generated by the PWM conversion, for example. Thus, in the inverter circuit 170, ON and OFF of the switching elements (respective FETs) are controlled based on the PWM driving signals outputted from the driving controller 110, and the voltage supplied from the secondary battery 101 is converted by the ON and OFF control of these switching elements to generate a driving voltage of each phase. The generated driving voltage for each phase is supplied to the coil for each phase in the motor 105.

The driving controller 110 relating to one embodiment of this invention includes a turn-on angle control signal generator 111 for intermittent driving (may simply be referred to “turn-on angle control signal generator 111”), a turn-on angle expansion width determination unit 112, a turn-on angle expansion unit 113, a driving waveform generator 114, a driving signal output unit 115, a driving voltage generator 117, a phase detector 118, an effective driving voltage multiplier 150 and a PWM modulator 160. The effective driving voltage multiplier 150 is a generic name for an effective driving voltage multiplier 150u, effective driving voltage multiplier 150v and effective driving voltage multiplier 150w for respective phases (U phase, V phase and W phase), and the PWM modulator 160 is a generic name for a PWM modulator 160u, PWM modulator 160v and PWM modulator 160w for respective phases (U phase, V phase and W phase). A memory (not depicted) to store various data used for calculation, intermediate data during processing and the like may be provided in the driving controller 110. This memory may be provided separately from the driving controller 110.

The turn-on angle control signal generator 111 generates a turn-on angle control signal representing a turn-on timing for each phase in the motor 105 based on the hall outputs of the respective phases from the motor 105. (b) in FIG. 3 depicts an example of the turn-on angle control signals for each phase, which are generated based on the hall output signals in (a) in FIG. 3, and U120, V120 and W120 represent the turn-on angle control signals for the U phase, V phase and W phase. Moreover, one period of the hall output signal corresponds to an electrical angle 360 degrees. As depicted in the drawing, this one period is divided into 6 phases from phase 1 to phase 6. The turn-on angle control signal U120 for the U phase becomes a high level in sections (phase 1, phase 2, phase 4 and phase 5), which correspond to the electrical angle of 120 degrees from each edge of the U-phase hall output, and becomes a low level in sections (phase 3 and phase 6), which correspond to the electrical angle of 60 degrees after the high level. Therefore, the turn-on angle control signal U120 is generated so that the high level section corresponding to the electrical angle of 120 degrees and the low level section corresponding to the electrical angle of 60 degrees appear in turns. Similarly, the turn-on angle control signals for the V phase and W phase are respectively generated based on the hall output for the V phase or W phase so that the high level section corresponding to the electrical angle of 120 degrees and the low level section corresponding to the electrical angle of 60 degrees appear in turns. The high level section in the turn-on angle control signal for each phase corresponds to a turn-on angle (a section in which the coil for each phase is brought into conduction) in case of the 120-degree turn-on driving. In this specification, more generally, in the turn-on angle control signal, the high level section that is triggered at each edge of the hall outputs for the respective phases and has an electrical angle less than 180 degrees may be referred to a reference turn-on angle.

The turn-on angle expansion width determination unit 112 relating to one embodiment of this invention determines a turn-on angle expansion width for expanding the reference turn-on angle of the turn-on angle control signal generated in the turn-on angle control signal generator 111, and outputs an expansion width signal representing the turn-on angle expansion width to the turn-on angle expansion unit 113. For example, the turn-on angle expansion width determination unit 112 is configured to include a monostable multivibrator circuit that detects rising edges and falling edges of the hall outputs for the respective phases, and outputs a high level signal (monostable multivibrator output signal) across a predetermined time (Ex_MM) since this detection timing. In such a case, the monostable multivibrator output signal outputted from the monostable multivibrator circuit becomes an expansion width signal. In an example of FIG. 3, ON and OFF of the hall output signal for each phase are switched every 180 degrees, however, by using a retriggerable monostable multivibrator as the turn-on angle expansion width determination unit 112, it is possible to output one-shot monostable multivibrator output signal every 60 degrees (instead of every 180 degrees) based on the hall output signals for the respective phase, which appear while shifting every 60 degrees. In other words, by using the retriggerable monostable multivibrator, as illustrated in (c) in FIG. 3, it is possible to output the monostable multivibrator output signal based on the respective edges of the hall output signals for the U phase, V phase and W phase, which appear while shifting every 60 degrees of the electrical angle.

The time Ex_MM during which the monostable multivibrator circuit outputs a one-shot high-level signal is determined as described below so that the high-level signal continues during a time period corresponding to the electrical angle of 60 degrees in the continuous turn-on shifting frequency ft corresponding to the continuous turn-on shifting speed Vt.

Ex_MM=(1/ft)*(60 degrees/360 degrees)=⅙ ft

By determining the time period Ex_MM as described above, the monostable multivibrator circuit can output the monostable multivibrator output signal (the expansion width signal) for the electrical angle corresponding to (V/Vt)*(60 degrees), when the vehicle speed V of the motor-assisted bicycle 1 is speed V (however, V is equal to or less than Vt). Therefore, when the vehicle speed V of the motor-assisted bicycle 1 is near zero, the expansion of the aforementioned time period is limited to almost zero degree of the electrical angle, and when the vehicle speed increases, a section during which the monostable multivibrator output signal (the high-level signal) is outputted is expanded to 60 degrees of the electrical angle, and when the vehicle speed reaches the continuous turn-on shifting speed Vt, the monostable multivibrator output signal is outputted across 60 degrees of the electrical angle. Thus, while the speed of the motor-assisted bicycle 1 changes from zero to Vt, as illustrated in (c) in FIG. 3, a signal width (which corresponds to the electrical angle) of the high-level signal, which is outputted from the turn-on angle expansion width determination unit 112, increases from 0 degree to 60 degrees proportionally to the speed V of the motor-assisted bicycle 1. In other words, when the speed V of the motor-assisted bicycle 1 becomes high speed, the electrical angle during which the high-level signal outputted from the turn-on angle expansion width determination unit 112 is outputted is expanded, and when V is equal to or greater than Vt, the monostable multivibrator output signal is outputted for the entire section of 60 degrees. In this embodiment, because a case is explained as an example where the motor driving control apparatus 102 is mounted on the motor-assisted bicycle 1, the expansion width of the turn-on angle is explained in relation to a relationship between the vehicle speed V of the motor-assisted bicycle 1 and the continuous turn-on shifting speed Vt. However, because the vehicle speed V of the motor-assisted bicycle 1 is proportional to the frequency of the driving voltage of the motor 105, the above explanation regarding the expansion width of the turn-on angle holds equivalent to the relationship between the frequency of the driving voltage of the motor 105 and the continuous turn-on shifting frequency ft. For example, when the frequency of the driving voltage of the motor 105 is f (however, f is equal to or less than ft), the monostable multivibrator circuit can output the monostable multivibrator output signal (the expansion width signal) only during the electrical angle corresponding to (f/ft)*(60 degrees). As described above, the motor driving control apparatus 102 of this embodiment can be used for driving the brushless motor, which is other than the motor for assisting the motor-assisted bicycle 1. When the motor driving control apparatus 102 of this embodiment is applied to the control of the brushless motor used for driving any apparatus other than the motor-assisted bicycle 1, it is possible to determine the expansion width of the reference turn-on angle based on the frequency of the driving voltage of the brushless motor and the continuous turn-on shifting frequency suitable for that purpose.

The turn-on angle expansion unit 113 expands the reference turn-on angle in the turn-on angle control signal for each phase, which was received from the turn-on angle control signal generator 111, based on the monostable multivibrator output signal (the expansion width signal) received from the turn-on angle expansion width determination unit 112. More specifically, the turn-on angle expansion unit 113 synthesizes, by ORing, the turn-on angle control signal for each phase and the monostable multivibrator output signal to expand the reference turn-on angle in the turn-on angle control signal for each phase. In this specification, the turn-on angle control signal whose reference turn-on angle is expanded may be referred to “expanded turn-on angle control signal”, and the turn-on angle (which represents the ON section of the expanded turn-on angle control signal by the electrical angle) after the expansion in the expanded turn-on angle control signal may be referred to “expanded turn-on angle”.

(c) in FIG. 3 illustrates examples of output patterns of the turn-on angle expansion width determination unit 112 (monostable multivibrator circuit), and (d) in FIG. 3 illustrates an example of the expanded turn-on angle control signal for V phase, which is synthesized by ORing the turn-on angle control signal V120 and the output pattern of the monostable multivibrator circuit. (c) and (d) in FIG. 3 respectively illustrate the output patterns of the monostable multivibrator circuit and the expanded turn-on angle control signal for V phase in a case where the speed V of the motor-assisted bicycle 1 is near zero (at stopping or immediately after the starting), a case where the speed V is low speed, a case where the speed V is relatively high speed (however, the speed V is less than the continuous turn-on shifting speed Vt), and a case where the speed V is equal to or greater than the continuous turn-on angle shifting speed Vt. When the speed V of the motor-assisted bicycle 1 is near zero, as illustrated in (c) in FIG. 3, there is almost no monostable multivibrator output signal (high-level section of the output pattern of the monostable multivibrator circuit) when converting into the electrical angle. Therefore, the expanded turn-on angle control signal (V_On signal) for V phase, which is generated by synthesizing, by ORing, the turn-on angle control signal V120 and the output pattern of the monostable multivibrator circuit, has almost the same ON/OFF pattern as that of the turn-on angle control signal V120. When V is low speed or when V is high speed (however, V is less than the continuous turn-on shifting speed Vt), as illustrated in (d) in FIG. 3, the expanded turn-on angle control signal for V phase (V_On signal) has an ON/OFF pattern in which the reference turn-on angle of the turn-on angle control signal V120 is expanded backwardly by the electrical angle of the monostable multivibrator output signal. Then, when V is equal to or greater than Vt, as illustrated in (c) in FIG. 3, the output pattern of the monostable multivibrator circuit is always high-level, the expanded turn-on angle control signal for V phase (V_On signal) also becomes always high-level. Therefore, the continuous turn-on state is obtained in which there is no turn-on stop section.

As a result, the turn-on angle expansion unit 113 can expand the reference turn-on angle of the initial turn-on angle control signal according to the vehicle speed of the motor-assisted bicycle 1 (or frequency of the driving voltage of the motor 105), backwardly. Reversely, it can be said that the turn-on stop section in the initial turn-on angle control signal is shortened forwardly. In (d) in FIG. 3, the example of the turn-on angle control signal for V phase was explained, however, also as for the turn-on angle control signals for other phases (U phase and W phase), the reference turn-on angle in the initial turn-on angle can similarly be expanded backwardly by the width corresponding to the electrical angle of the monostable multivibrator output signal according to the vehicle speed of the motor-assisted motor 1 (or frequency of the driving voltage of the motor 105) by synthesizing, by ORing, the turn-on angle control signal from the turn-on angle control signal generator 111 and the output patterns from the monostable multivibrator circuit. The monostable multivibrator circuit in this embodiment generates the monostable multivibrator output signal from the respective edges of the hall output signals for the respective phases. Therefore, the output patterns of the monostable multivibrator circuit can be used to generate the expanded turn-on angle control signal for each of the U phase, V phase and W phase.

The expanded turn-on angle control signals for the respective phases, which are generated as described above, are outputted to the driving signal output unit 115. The driving signal output unit 115 will be explained later.

The phase detector 118 relating to one embodiment of this invention obtains a high-resolution phase output for the sine wave driving based on the hall output signals and the output signals (the voltage waveform and current waveform or either of them) from the current and voltage waveform detector 107. The driving waveform generator 114 relating to one embodiment of this invention generates a waveform signal to drive the motor 105 by the continuous turn-on by driving the respective FETs of the inverter circuit 170 through the effective driving voltage multiplier 150, PWM modulator 160 and driving signal output unit 115. The driving waveform generator 114 predicts a magnetic pole position provided in a rotor in the motor 105, for example, based on the hall output signals from the motor 105, and generates a turn-on waveform based on the predicted position of the magnetic pole, and further based on a lead angle value, which is calculated based on an input representing the vehicle speed of the motor-assisted bicycle 1, which is calculated from the hall output signals, an input representing a pedaling force or pressure, which is detected by the torque sensor 103, an input representing the brake force detected by the brake sensor 104 and signals other than these inputs. The driving voltage generator 117 generates a driving voltage code by digitizing an input (e.g. assist ratio) from the control panel 106, the input representing the vehicle speed of the motor-assisted bicycle 1, which is calculated from the hall output signals, the input representing the pedaling force or pressure detected by the torque sensor 103, the input representing the brake force detected by the brake sensor 104 and an output voltage from the secondary battery 101. The effective driving voltage multiplier 150 (each of 150u, 150v and 150w) controls the level of outputs of the driving waveform generator 114 based on this driving voltage code. The PWM modulator 160 converts the output waveform of the effective driving voltage multiplier 150 into a binary PWM signal to drive the inverter through the driving signal output unit 115. The specific calculation method of the duty ratio and lead angle value are described in detail in a Japanese Patent Application No. 2012-549736 filed by this applicants, which is U.S. Pat. No. 9,162,730 incorporated herein by reference.

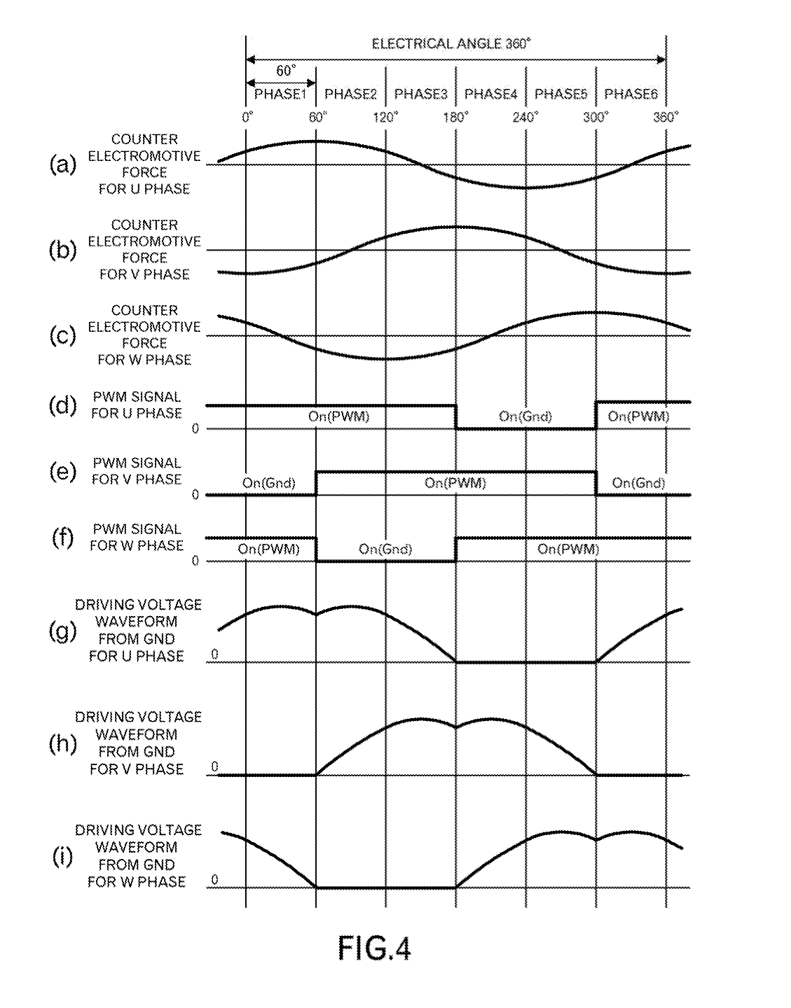

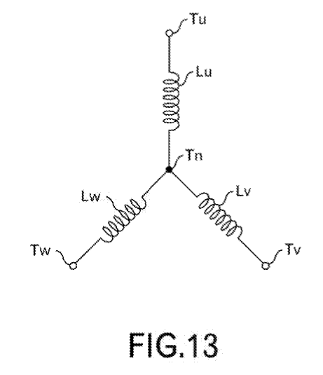

FIG. 4 illustrates examples of the PWM signals for the continuous driving for the respective phase, which are generated as described above. In FIG. 4, the PWM signal for the U phase is an example of the PWM signal for the high-side FET (Sᵤₕ), which performs switching for the U phase, the PWM signal for the V phase is an example of the PWM signal for the high-side FET (Sᵥₕ), which performs switching for the V phase, and the PWM signal for the W phase is an example of the PWM signal for the high-side FET (S_{wh}), which performs switching for the W phase. In FIG. 4, in a section represented as “ON(PWM)”, a driving voltage signal modulated by PWM with a duty ratio set as described above is generated, and in a section represented as “ON(Gnd)”, a driving voltage signal modulated by PWM with a duty ratio “0” is generated. Although the PWM signals for the low-side FETs for the respective phases are not depicted, when the PWM signals for the high-side FETs for the respective phases are ON, the PWM signals for the low-side FETs for the respective phases are OFF, and when the PWM signals for the high-side FETs for the respective phases are OFF, the PWM signals for the low-side FETs for the respective phases are ON. When these PWM signals for the respective phases are outputted to control terminals of the FETs for the corresponding phases in the inverter circuit 170, the driving voltage having a similar waveform (typically, the sine wave) for the continuous driving to the instant induced electromotive force, which occurs in the coil for each phase, is impressed to the coil of each phase in the motor 105. However, as described later, please note that the outputs of the driving signals to the FETs in the inverter circuit 170 are made actually from the driving signal output unit 115 instead of the PWM modulator 160. At that time, the voltage waveform represented by the substantial waveform at the coil terminal for each phase, which is driven by the PWM signal, in other words, the PWM duty for each phase, is a driving voltage waveform from the ground. It seems at a glance that this waveform is not the sine wave, however, this is because the voltage waveform from the ground as a reference is outputted from the inverter output terminal. When watching the driving voltage waveform from the ground for each phase by using, as a reference, a median electric potential of the outputs for the respective phases U, V and W as the electrical potential at a connection neutral terminal Tn of the U, V and W coils in FIG. 13, in other words, an average voltage of the voltages from the ground for the respective coils, the voltage impressed to the coil for each phase for the neutral terminal is the same as the aforementioned waveform of the counter electromotive force. At this time, when the driving voltage from the neutral terminal is greater than the counter electromotive force, the state represents a powering state, in other words, an acceleration state, and when the driving voltage viewed from the neutral point is less than the counter electromotive force, the state represents a regenerative braking state, in other words, a deacceleration state.

The driving signal output unit 115 relating to one embodiment of this invention generates the PWM driving signals by controlling ON and OFF of the PWM signal for each phase with the expanded turn-on angle control signal for the corresponding phase from the turn-on angle expansion unit 113 to output the generated PWM driving signals to FETs for the respective phases in the inverter circuit 170. The PWM signal for each phase is received from the driving waveform generator 114 through the effective driving voltage multiplier 150 and the PWM modulator 160. More specifically, the driving signal output unit 115 relating to one embodiment of this invention outputs the PWM signal for each phase, which is received from the driving waveform generator 114 through the effective driving voltage multiplier 150 and the PWM modulator 160, within the sections of the expanded turn-on angle of the expanded turn-on angle control signal for each phase from the turn-on angle expansion unit 113. On the other hand, in a low-level section of the expanded turn-on angle control signal, the corresponding FET in the inverter circuit 170 is controlled as being in the high-impedance state.

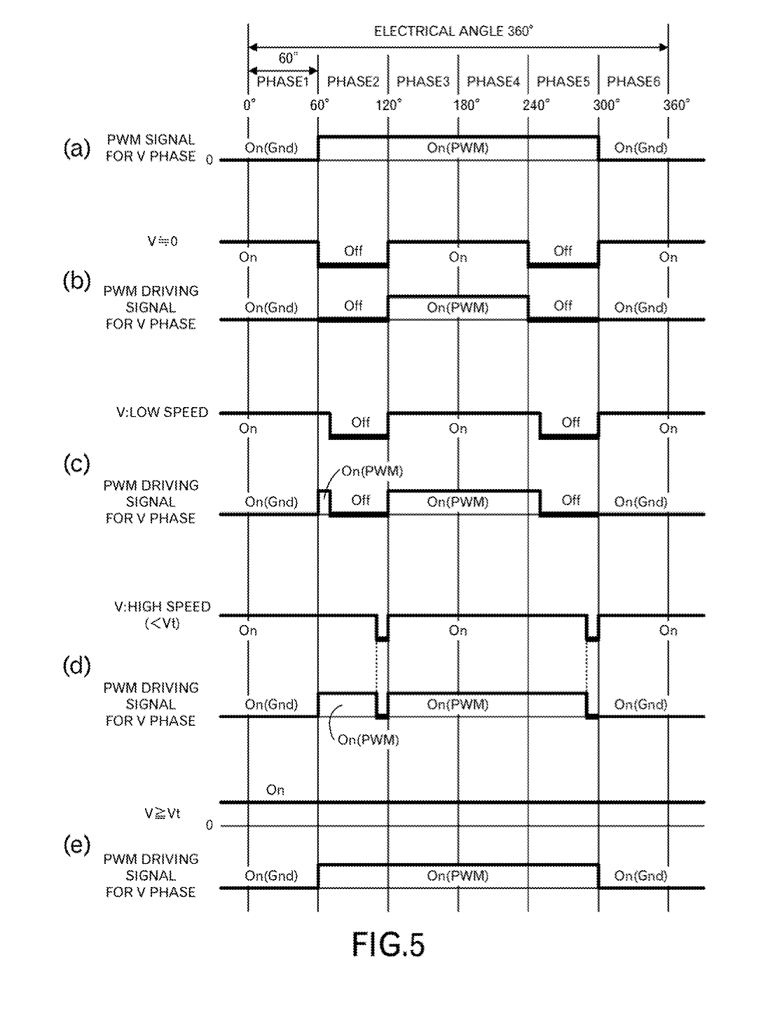

FIG. 5 illustrates an example of the PWM driving signal for the V phase, which is outputted from the driving signal output unit 115 to the inverter circuit 170. Similarly to (c) and (d) in FIG. 3, FIG. 5 illustrates an example of the PWM driving signal for V phase for each of a case where the speed V of the motor-assisted bicycle 1 is near zero (at stopping or immediately after starting), a case where the speed V is low, a case where the speed V is relatively high (however, the speed is less than the continuous turn-on shifting speed Vt) and a case where the speed V is equal to or greater than the continuous turn-on shifting speed Vt. (a) in FIG. 5 depicts the PWM signal for V phase, which is depicted in FIG. 4 (a signal inputted from the driving waveform generator 114 to the driving signal output unit 115) again, and (b) to (e) of FIG. 5 respectively depict the expanded turn-on angle control signal (V_On signal) and the PWM driving signal for V phase (a signal outputted from the driving signal output unit 115 to the inverter circuit 170) in a case where the speed V of the motor-assisted bicycle 1 is near zero, a case where the speed V is low, a case where the speed V is relatively high (however, the speed V is less than the continuous turn-on shifting speed Vt) and a case where the speed V is equal to or greater than the continuous turn-on shifting speed Vt.

As illustrated in (b) in FIG. 5, when the speed V of the motor-assisted bicycle 1 is near zero, the PWM signal for V phase is outputted within the expanded turn-on angle (the entire of the phase 1, 3, 4 and 6) in the expanded turn-on angle control signal for V phase to the high-side FET (Sᵥₕ) and the low-side FET (Sᵥₗ) for V-phase switching in the inverter circuit 170. As described above, the output voltage waveform to the low-side FET (Sᵥₗ) has an inverse polarity of the output voltage waveform to the high-side FET (Sᵥₕ). On the other hand, because the sections (phases 2 and 5) of 60 degrees in which the expanded turn-on angle control signal for V phase is low correspond to the turn-on stop section, the high-side FET (Sᵥₕ) and the low-side FET (Sᵥₗ) are controlled as being in the high-impedance state in those sections.

Similarly to this case, also in the case where the speed V of the motor-assisted bicycle 1 is low and the case where the speed V of the motor-assisted bicycle 1 is high as illustrated in (c) and (d) in FIG. 5, the PWM signal for V phase is outputted within the expanded turn-on angle (high-level section) in the expanded turn-on angle control signal for V phase to the high-side FET (Sᵥₕ) and the low-side FET (Sᵥₗ) for V-phase switching in the inverter circuit 170, and within the sections in which the expanded turn-on angle control signal for V phase is in the low level, the high-side FET (Sᵥₕ) and the low-side FET (Sᵥₗ) are controlled as being in the high-impedance state.

As being apparent when comparing (b) to (d) in FIG. 5, when the speed V of the motor-assisted bicycle 1 increases (namely, the frequency of the driving voltage of the motor 105 increases), the expanded turn-on angle in the expanded turn-on angle control signal becomes larger. Then, as illustrated in (e) in FIG. 5, when the speed V reaches the continuous turn-on shifting speed Vt (when the frequency of the driving voltage of the motor 105 reaches the continuous turn-on shifting frequency ft), the expanded turn-on angle reaches 180 degrees, and the expanded turn-on angle control signal becomes high-level during one entire period of the hall output signal. Therefore, the PWM signal for V phase is outputted during one entire period of the hall output signal to the high-side FET (Sᵥₕ) and the low-side FET (Sᵥₗ) for the V-phase switching in the inverter circuit 170. At this time, the driving of the motor 105 becomes the same as the driving control in the driving method by continuous turn-on. The same control as the aforementioned control is performed for the phases other than the phase V.

As described above, in one embodiment of this invention, the continuous turn-on driving waveform signal for each phase from the driving waveform generator 114 is outputted to the corresponding FET in the inverter circuit 170 through the effective driving voltage multiplier 150 and the PWM modulator 160 within the sections of the extended turn-on angle in the expanded turn-on angle control signal for each phase, and on the other hand, in the section in which the expanded turn-on angle control signal is in the low level, the corresponding FET in the inverter circuit 170 is controlled as being in the high-impedance state. At this time, the expanded turn-on angle of the expanded turn-on angle control signal for each phase is continuously expanded according to the speed V of the motor-assisted bicycle 1 (according to the frequency f of the driving voltage of the motor 105), and when the speed V of the motor-assisted bicycle 1 is equal to or greater than the predetermined continuous turn-on shifting speed Vt (when the frequency f of the driving voltage of the motor 105 is equal to or greater than the predetermined continuous turn-on shifting frequency ft), the expanded turn-on angle becomes the turn-on angle throughout the one period of the hall output signal. Then, along with the expansion of the turn-on angle, the section in which the continuous turn-on driving waveform signal is outputted is prolonged, and when the speed V is equal to or greater than the continuous turn-on shifting speed Vt, the motor 105 is driven by the PWM signals of the continuous turn-on driving waveform throughout one period of the hall output signal.

Therefore, immediately after starting of the motor-assisted bicycle 1, the driving control of the motor 105 is performed in the driving method similar to the driving method by intermittent turn-on, and along with the acceleration of the motor-assisted bicycle 1, the turn-on angle is continuously expanded proportionally to the speed of the motor-assisted bicycle 1, and at the predetermined continuous turn-on shifting speed Vt, the entire section becomes the turn-on section, and the driving control of the motor 105 is performed with the driving voltage similar to that in the driving method by continuous turn-on. Thus, according to this embodiment, the driving control in the driving method by intermittent turn-on is performed in the low speed, and when the speed is equal to or greater than the predetermined speed, the driving control in the driving method by continuous turn-on is performed. Therefore, the motor 105 is driven with high efficiency.

In addition, as being apparent when compared the PWM driving signals for V phase in (d) and (e) in FIG. 5, the turn-on stop period immediately before shifting to the driving method by continuous turn-on is continuously shortened and disappears. Therefore, it is possible to suppress the vibration and/or noise when shifting from the driving method by intermittent turn-on to the driving method by continuous turn-on, compared with a conventional switching method for simply switching between the driving signal in the driving method by intermittent turn-on and the driving signal in the driving method by continuous turn-on. In order to realize smooth shifting from the driving method by intermittent turn-on to the driving method by continuous turn-on, the output torques of the motor 105 before and after switching the driving method are made to be identical. Therefore, it is notable that there is no need to perfectly adjust the difference in the effective driving voltage between pre-switching and post-switching. In other words, in this embodiment, without adjusting the output torque of the motor 105, the smooth shifting from the driving method by intermittent turn-on to the driving method by continuous turn-on can be realized with a simple configuration in which a monostable multivibrator circuit to only prolong the turn-on section by a predetermined time period is provided. Furthermore, in the processing for expanding the turn-on angle in one embodiment of this invention, a method is employed in which one monostable multivibrator in the turn-on angle expansion width determination unit 112 generates the expansion width signal by triggering with every edges of the hall outputs and the turn-on angle is expanded by synthesizing, in the turn-on angle expansion unit 113, the expansion width signal and the turn-on angle control signal for each phase from the turn-on angle control signal generator 111. However, a method may be employed in which a monostable multivibrator may be individually provided, in the turn-on angle expansion unit 113, for the output for each of the phases U, V and W from the turn-on angle control signal generator 111. Even by such an embodiment, it is possible to expand the reference turn-on angle for each phase backwardly.

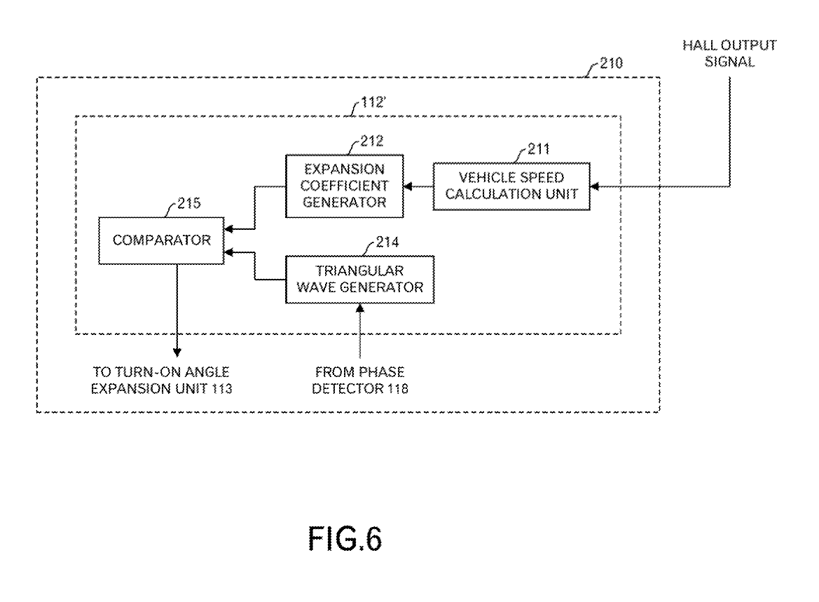

Next, by referring to FIGS. 6 to 10, a motor driving control apparatus relating to another embodiment of this invention will be explained. FIG. 6 is a functional block diagram representing functions of a turn-on angle expansion width determination unit 112′ provided in the motor driving control apparatus relating to another embodiment of this invention. The motor driving control apparatus relating to this embodiment is an apparatus in which a driving controller 210 is provided in the motor driving control apparatus 102 illustrated in FIG. 2 instead of the driving controller 110. This driving controller 210 has the configuration similar to the driving controller 110 except providing the turn-on angle expansion width determination unit 112′ instead of the turn-on angle expansion width determination 112. Therefore, the detailed explanation other than the turn-on angle expansion width determination unit 112′ is omitted.

The driving controller 210 relating to one embodiment of this invention is different from the driving controller 110 in view of expanding the turn-on section of the turn-on angle control signal for each phase, which are received from the turn-on angle control signal generator 111, based on a result of comparing an output of a turn-on angle expansion function with a triangular wave obtained from high-resolution phase information for the sine-wave driving, which are obtained by interpolating, in the phase, the section between the edges of the hall output signals or by calculation from the voltage waveform and current waveform of each phase coil, which are obtained from the motor 105.

More specifically, the driving controller 210 relating to one embodiment of this invention has the turn-on angle control signal generator 111, a turn-on angle expansion width determination unit 112′, the turn-on angle expansion unit 113, a driving waveform generator 114 and the driving signal output unit 115. As illustrated in FIG. 6, this turn-on angle expansion width determination unit 112′ has a vehicle speed calculation unit 211, an expansion coefficient generator 212, a triangular wave generator 214 and a comparator 215.

The vehicle speed calculation unit 211 relating to one embodiment of this invention calculates a rotation rate of the rotor per a unit time, based on the hall output signals from the motor 105, and calculates the vehicle speed V of the motor-assisted bicycle 1 based on the rotation rate of the rotor and a reduction ratio of the motor 105. The calculated vehicle speed V of the motor-assisted bicycle 1 is outputted to the expansion coefficient generator 212.

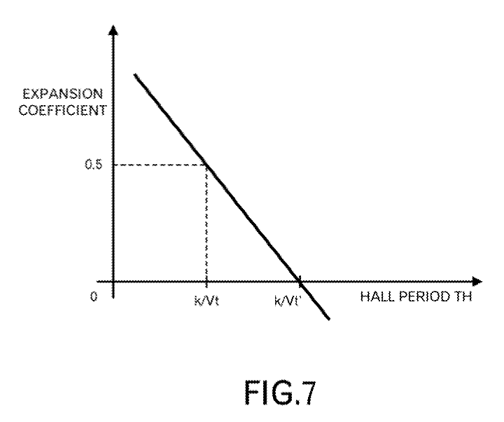

The expansion coefficient generator 212 relating to one embodiment of this invention calculates a function value corresponding to the vehicle speed V received from the vehicle speed calculation unit 211 by using a predetermined turn-on angle expansion function. FIG. 7 illustrates an example of the turn-on angle expansion function. As illustrated in FIG. 7, the turn-on angle expansion function is a function that correlates a reciprocal of the vehicle speed of the motor-assisted bicycle 1 (or a driving frequency of the driving voltage of the motor 105) with the turn-on angle expansion coefficient associated with the expansion width of the turn-on angle. As for the turn-on angle expansion function in FIG. 7, the reciprocal of the vehicle speed V of the motor-assisted bicycle 1 (or the driving frequency of the driving voltage of the motor 105) is correlated with the turn-on angle expansion coefficient associated with the expansion width of the turn-on angle so that, in case where the vehicle speed V of the motor-assisted bicycle 1 is the continuous turn-on shifting speed Vt (the frequency of the driving voltage of the motor 105 is the continuous turn-on shifting frequency ft), the turn-on angle expansion coefficient is 0.5 (which is a value equal to the amplitude of the triangular wave signal described later), and when the vehicle speed V (the frequency of the driving voltage of the motor 105) increases, the turn-on angle expansion coefficient increases. In addition, in the turn-on angle expansion function in FIG. 7, in case where the vehicle speed V of the motor-assisted bicycle 1 is Vt′ that is less than the continuous turn-on shifting speed Vt (in case where the driving frequency is a threshold frequency ft′ that is less than the continuous turn-on shifting frequency ft), the turn-on angle expansion coefficient is negative. The speed Vt′ is a lower limit of the vehicle speed of the motor-assisted bicycle 1, at which the phase interpolation described later can be performed with high accuracy based on the hall output signals, and may be a value between 0.2 km/h and 1.0 km/h, for example.

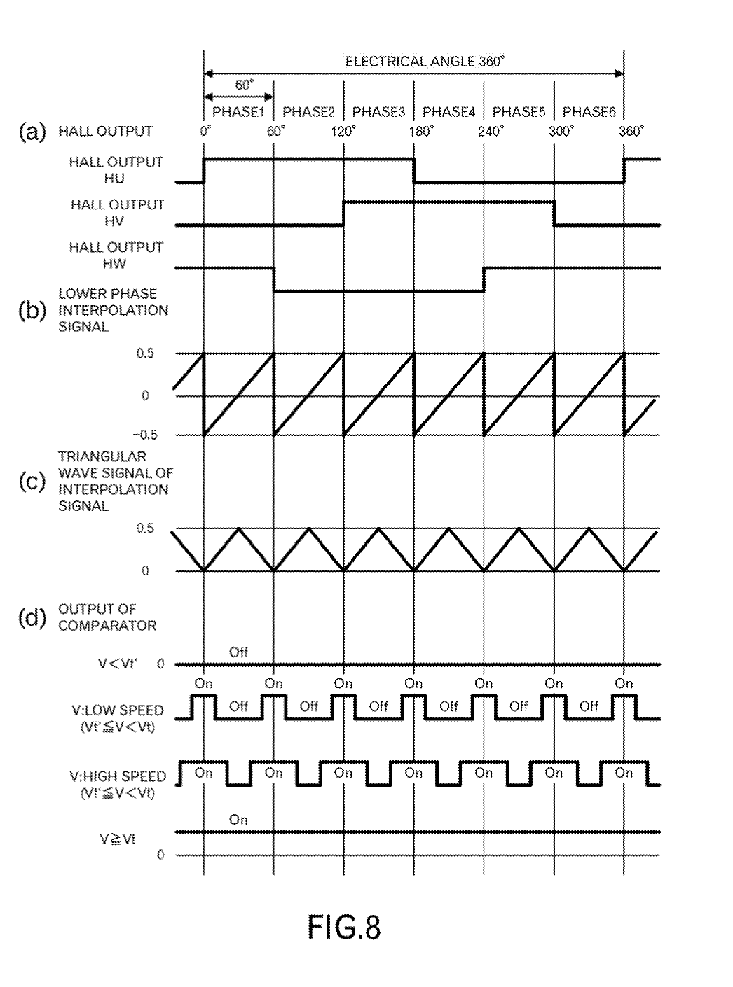

The phase signal that is one input relating to one embodiment of this invention is high-resolution phase information for the sine-wave driving, which is generated by interpolating the section between edges of the hall output signals for the respective phases from the motor 105 or is calculated from the voltage waveform and the current waveform of each phase coil from the motor 105. In this example, FIG. 8 illustrates an example of a lower phase interpolation signal generated by interpolating the hall output signals, however, a similar waveform is obtained in case of the phase signal obtained from other signals. For example, the phase detector 118 detects the respective edges of the hall output signals for the respective phase, which are illustrated in (a) of FIG. 8, and, as illustrated in (b) of FIG. 8, by interpolating the section between edges by a linear function, the phase detector 118 generates the lower phase interpolation signal that has the sawtooth shape.

The triangular wave generator 214 relating to one embodiment of this invention generates a triangular wave by calculating an absolute value of the lower phase interpolation signal generated by the phase detector 118, and delays or advances the generated triangular wave by 30 degrees of the electrical angle, and outputs the delayed or advanced triangular wave to the comparator 215. An example of the triangular wave outputted to comparator 215 as described above is depicted in (c) of FIG. 8.

The comparator 215 relating to one embodiment of this invention uses the turn-on angle expansion coefficient from the expansion coefficient generator 212 as a reference signal to generate an output signal (hereinafter, which may be referred to “a comparator output signal” in this specification) based on the comparison result between the reference signal and the triangular wave from the triangular wave generator 214. More specifically, the comparator 215 outputs a high-level signal (On signal) when the triangular wave from the triangular wave generator 214 is less than the reference signal (the turn-on angle expansion coefficient from the expansion coefficient generator 212), and outputs a low-level signal (Off signal) when the triangular wave from the triangular wave generator 214 is greater than the reference signal. The generated output signal is outputted to the turn-on angle expansion unit 113.

(d) of FIG. 8 illustrates an example of an output signal of the comparator 215. When the vehicle speed V of the motor-assisted bicycle 1 is less than Vt′ (the frequency f of the driving voltage of the motor 105 is less than ft′), the turn-on angle expansion coefficient from the expansion coefficient generator 212 is always negative, therefore, the triangular wave from the triangular wave generator 214 is greater than the expansion coefficient during all sections. Accordingly, the output signal of the comparator 215 becomes the low level during all sections. Next, in case where V is equal to or greater than Vt′ and is less than Vt (f is equal to or greater than ft′ and less than ft), when V increases, sections in which the turn-on angle expansion coefficient from the expansion coefficient generator 212 is greater than the triangular wave from the triangular wave generator 214 expand, therefore, the section of the high level in the output signal of the comparator 215 also expands according to this. Then, in case where V is equal to or greater than Vt (f is equal to or greater than ft), the value of the turn-on angle expansion coefficient from the expansion coefficient generator 212 becomes equal to or greater than 0.5, therefore, this expansion coefficient is always greater than the triangular wave from the triangular wave generator 214, and the output signal of the comparator 215 becomes the high level during all sections.

The output signal from the comparator 215 is outputted to the turn-on angle expansion unit 113 as the expansion width signal. The turn-on angle expansion unit 113 expands the reference turn-on angle of the turn-on angle control signal for each phase, which is received from the turn-on angle control signal generator 111 based on the expansion width signal received from the turn-on angle expansion width determination unit 112′. More specifically, the turn-on angle expansion unit 113 synthesizes the turn-on angle control signal for each phase and the output signal of the comparator 215 by ORing to generate the expanded turn-on angle control signal.

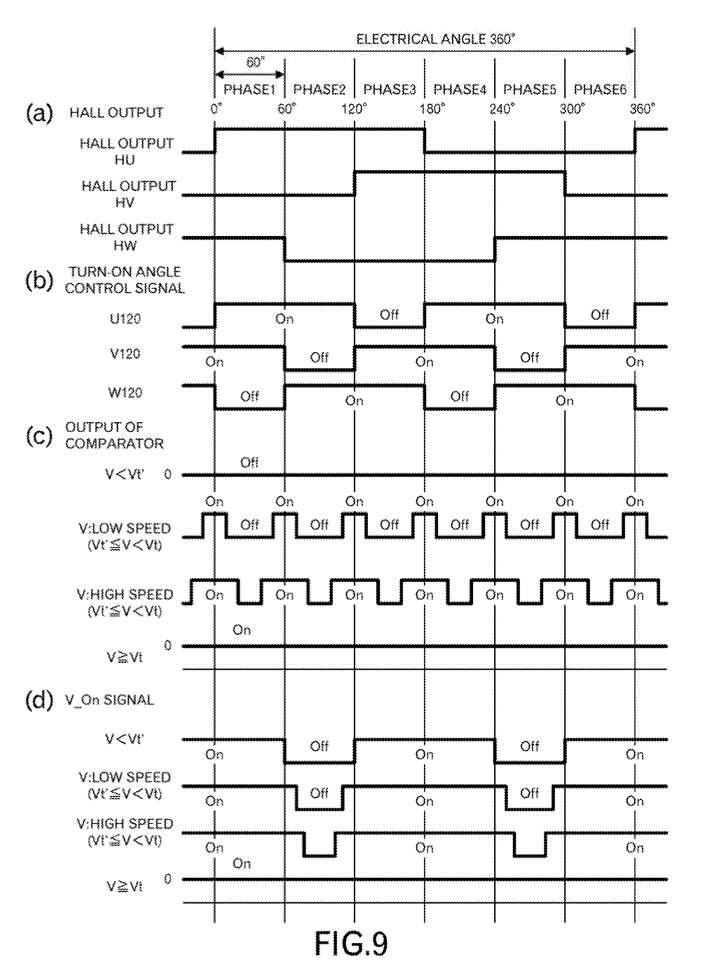

FIG. 9 depicts timing charts representing an example of the expanded turn-on angle control signals (V_On signal) for V phase, which are generated in the embodiment of FIG. 6, and (a) of FIG. 9 depicts a hall output signal for each phase from the motor 105, similarly to (a) of FIG. 3, (b) of FIG. 9 depicts the turn-on angle control signal for each phase, which is generated in the turn-on angle control signal generator 111, similarly to (b) of FIG. 3, (c) of FIG. 9 depicts an output signal from the comparator 215, similarly to (d) of FIG. 8, and (d) of FIG. 9 depicts the expanded turn-on angle control signal for V phase (V_On signal). The expanded turn-on angle control signal (V_On signal) depicted in (d) of FIG. 9 is obtained by synthesizing, by ORing in the turn-on angle expansion unit 113, the turn-on angle control signal V120 for V phase and the output signal from the comparator 215, which is depicted in (c) of FIG. 9.

As depicted in (d) of FIG. 9, in case of V<Vt′ (f<ft′), the comparator output signal is in the low level during all sections as depicted in (c) of FIG. 9, therefore, the expanded turn-on angle control signal (V_On signal) for V phase, which is synthesized by ORing the turn-on angle control signal V120 and the comparator output signal, has the same ON/OFF pattern as the turn-on angle control signal V120. In case where V is equal to or greater than Vt′ and is less than Vt (f is equal to or greater than ft′ and is less than ft), as depicted in (d) of FIG. 9, the expanded turn-on angle control signal (V_On signal) for V phase has an ON/OFF pattern in which the reference turn-on angle (i.e. high-level section) of the turn-on angle control signal V120 is expanded forwardly and backwardly by the electrical angle corresponding to the high-level section of the comparator output signal depicted in (c) of FIG. 9. Then, in case where V is equal to or greater than Vt (f is equal to or greater than ft), as depicted in (c) of FIG. 9, the comparator output signal is always in high level, therefore, the expanded turn-on angle control signal (V_On signal) for V phase is always in the high level, and the turn-on stop section disappears. In FIG. 9, although only the expanded turn-on angle control signal for V phase is depicted, the expanded turn-on angle control signals for other phases (i.e. U phase and W phase) are similarly generated. The generated expanded turn-on angle control signal for each phase is outputted to the driving signal output unit 115.

As described above, the driving signal output unit 115 generates the PWM driving signals by performing control of ON and OFF for the PWM signal for each phase, which is received from the driving waveform generator 114 through the effective driving voltage multiplier 150 and PWM modulator 160, by the expanded turn-on angle control signal for corresponding phase from the turn-on angle expansion unit 113, and outputs the generated PWM driving signals to respective FETs in the inverter circuit 170.

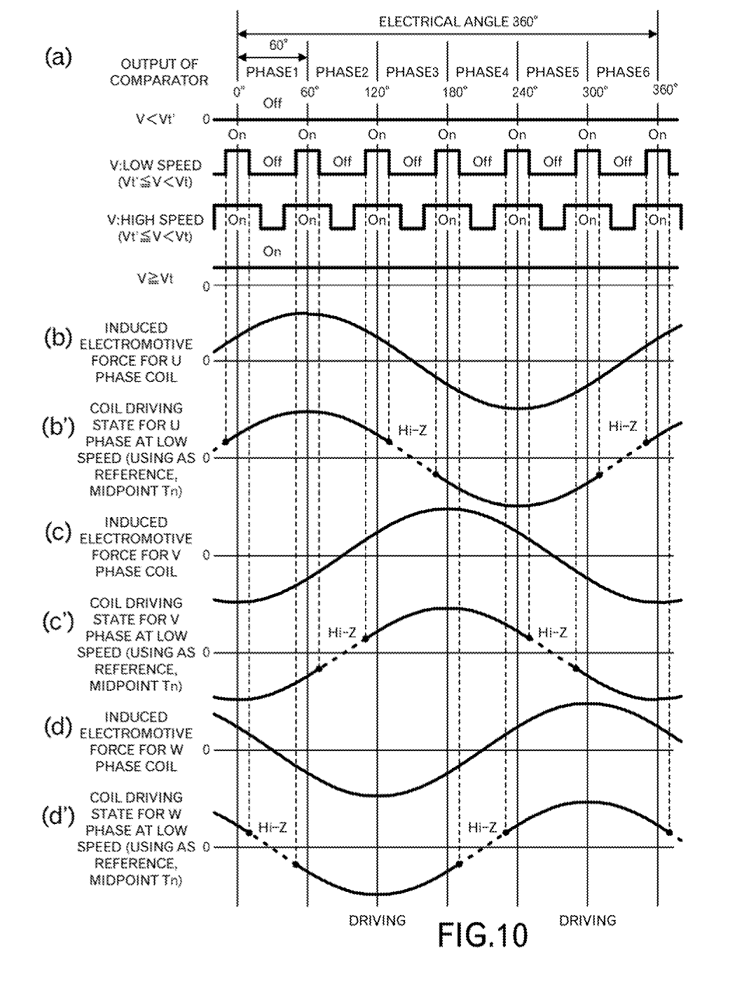

Thus, in this embodiment, by using the function value of the turn-on angle expansion function, as the reference value, the expansion width signal to determine the expansion width of the turn-on angle control signal (output signal of the comparator 215) is generated based on the comparison result of this reference value with the triangular wave generated based on the phase signal, which is generated by the phase detector 118 by interpolating, in phase, the section between edges of the hall output signals or generated by calculation from the instantaneous voltage and/or current for each phase coil. The expansion width signal generated as described above is positioned before and after the reference turn-on angle of the turn-on angle control signal. Therefore, the turn-on angle control signal is expanded in both of the forward direction and backward direction. Here, FIG. 10 depicts timing charts representing the comparator output signal in one embodiment of this invention, the induced electromotive force for each phase and the final driving voltage waveform for each phase coil, which is outputted by the inverter circuit 170. Typically, in the driving method by intermittent turn-on, by providing the turn-on stop section before and after the zero crossing point of the induced electromotive force that appears in the coil winding for each phase, the flow of the phase current in the coil winding, which has the opposite polarity to the driving voltage, is prevented at control of current commutation. As illustrated in FIG. 10, in one embodiment of this invention, when the vehicle speed V approaches Vt, the output timing of the comparator output signal from the comparator 215 is controlled so that ON of the comparator output signal is expanded toward the zero crossing point of the induced electromotive force for each phase from both edges, forwardly and backwardly.

Accordingly, until the vehicle speed V reaches Vt, the OFF section of the comparator output signal exists near the zero crossing point of the induced electromotive force for each phase, and the high impedance (Hi-z) state is realized near the driving zero crossing point for each phase like the final driving voltage waveform for each phase coil. Therefore, there is no danger of the flow of the large phase current that has the opposite polarity, and it is possible to smoothly shift to the continuous turn-on control. In addition, because shifting to the continuous turn-on control is smooth, it is difficult for the rider to feel the abnormal sound and/or vibration, compared with the embodiment depicted in FIG. 2, even when the continuous turn-on shifting speed Vt is set to be a less value.

In the aforementioned embodiment, by changing, for example, the waveform in the symmetry of the triangular wave, or by advancing or delaying the phase of the triangular wave, it is also possible to expand the reference turn-on angle of the turn-on angle control signal only forwardly or only backwardly. Furthermore, in the aforementioned embodiment, the signals from the turn-on angle control signal generator 111 and the turn-on angle expansion width determination unit 112 are synthesized by ORing in the turn-on angle expansion unit 113. However, the turn-on angle control signal generator 111 may primarily generate the turn-on angle control signal with a width that is variable due to the speed and the phase signal.

Moreover, according to the aforementioned embodiment, the turn-on angle expansion function in this embodiment is defined so that the function outputs a value less than the lower limit of the triangular wave in a range of V<Vt′ so as to substantially compare the phase signal obtained by the phase detection with the triangular wave, after the vehicle speed V of the motor-assisted bicycle 1 increases to an extent that the phase detection is performed, namely, the phase signal with high resolution can be generated with high accuracy (i.e. after the frequency of the driving voltage of the motor 105 becomes large). Therefore, the expansion of the reference turn-on angle, which is performed by using the phase signal generated by the phase detection and the triangular wave, is not performed in a speed range (V<Vt′) in which the accuracy of the phase detection is bad. Then, the expansion of the reference turn-on angle is performed based on the triangular wave after the speed becomes in a speed range (V is equal to or greater than Vt′) in which a certain degree of accuracy of the phase detection is obtained. Accordingly, the deterioration of the efficiency is prevented, which is caused by expanding the turn-on angle by using the phase signal with low accuracy.

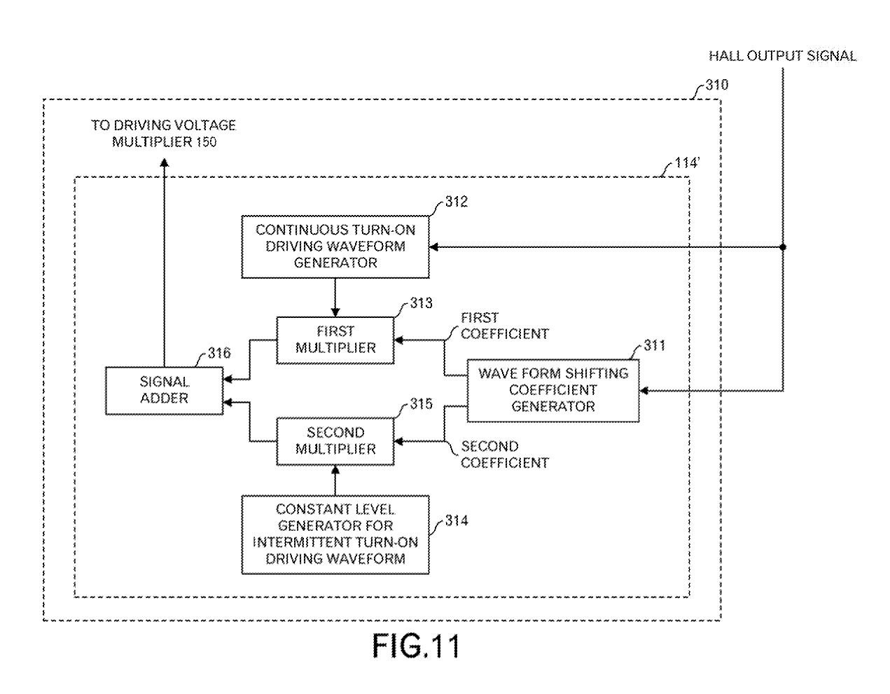

Next, still another embodiment of this invention will be explained by using FIG. 11. FIG. 11 is a block diagram representing functions of the driving waveform generator 114′ relating to this embodiment of this invention. The motor driving control apparatus relating to this embodiment has a driving controller 310 instead of the driving controller 110. This driving controller 310 has a similar configuration to the driving controller 110 except providing the driving waveform generator 114′ instead of the driving waveform generator 114. Therefore, the detailed explanation for portions other than the driving waveform generator 114′ will be omitted.

The driving controller 310 relating to one embodiment of this invention generates, as a driving signal to be inputted to the effective driving voltage multiplier 150, not only the driving signal for the continuous turn-on driving but also the driving signal for the intermittent turn-on driving. In view of utilization of both of them, the driving controller 310 is different from the driving controller 110 in FIG. 2.

More specifically, the driving controller 310 relating to one embodiment of this invention has the turn-on angle control signal generator 111 for the intermittent driving, the turn-on angle expansion width determination unit 112, the turn-on angle expansion unit 113, a driving waveform generator 114′, the driving voltage generator 117, the phase detector 118, the effective driving voltage multiplier 150, the PWM modulator 160, and the driving signal output unit 115. As illustrated in FIG. 11, this driving waveform generator 114′ has a waveform shifting coefficient generator 311, a continuous turn-on driving waveform generator 312, a first multiplier 313, a constant level generator 314 for the intermittent turn-on driving waveform, a second multiplier 315 and a signal adder 316.

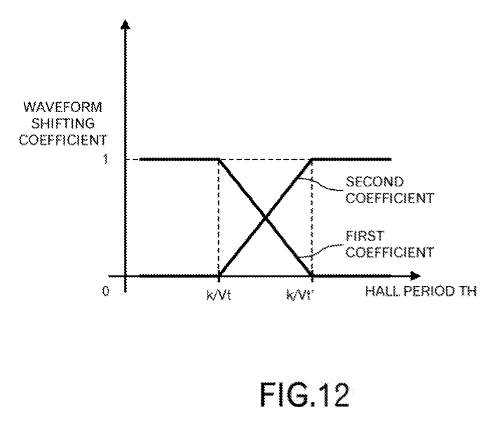

The waveform shifting coefficient generator 311 relating to one embodiment of this invention calculates a waveform shifting coefficient that is a function value corresponding to the vehicle speed V of the motor-assisted bicycle 1 by using a predetermined waveform shifting function. FIG. 12 depicts an example of the waveform shifting function. As illustrated in FIG. 12, the waveform shifting function is a function that correlates a reciprocal of the vehicle speed V of the motor-assisted bicycle 1 (or frequency f of the driving voltage of the motor 105) with the waveform shifting coefficients. The waveform shifting coefficient is an arbitrary value that is equal to or greater than 0 and equal to or less than 1. The waveform shifting coefficient generator 311 determines the waveform shifting coefficients corresponding to the reciprocal of the vehicle speed V of the motor-assisted bicycle 1 (or frequency f), which is calculated from the hall output signals, by using the waveform shifting function depicted in FIG. 12, for example. The first coefficient of the waveform shifting coefficients determined by the waveform shifting function is 0 when the vehicle speed V of the motor-assisted bicycle 1 is Vt′ (the frequency f is ft′), and is 1 when the vehicle speed V of the motor-assisted vehicle 1 is Vt (the frequency f is ft). The meaning and range of the speed Vt (frequency ft) and the speed Vt′ (frequency ft′) are as described above. The first coefficient of the waveform shifting coefficients, which is calculated as described above, is outputted to the first multiplier 313 and the second coefficient is outputted to the second multiplier 315.

The continuous turn-on driving waveform generator 312 relating to one embodiment of this invention generates a waveform signal for performing the continuous turn-on driving for the motor 105 with the sine wave driving voltage by switching the respective FETs of the inverter circuit 170. The continuous turn-on driving waveform generator 312 calculates a lead angle and the like based on the hall outputs from the motor 105 or the instantaneous voltage waveform and/or current waveform for each phase coil from the current and voltage waveform detector 107 and various input signals other than those, and generates the waveform signal for the continuous driving for each phase, which is to be outputted to the motor 105, based on the phase output signal with high resolution, which is based on the calculated lead angle. The method for generating the waveform signal in the continuous turn-on driving waveform generator 312 is the same as the method for generating the waveform signal in the driving waveform generator 114, therefore, the detailed explanation is omitted. The generated continuous turn-on driving waveform signal for each phase is outputted to the first multiplier 313.

The constant level generator 314 for the intermittent turn-on driving waveform, which relates to one embodiment of this invention, generates a waveform signal for the intermittent driving, which has a constant level, as a waveform signal for performing the intermittent turn-on driving for the motor 105 with the rectangular wave driving voltage by switching the respective FETs in the inverter circuit 170 after passing through the effective driving voltage multiplier 150 and the PWM modulator 160. This waveform signal for the intermittent driving is outputted to the second multiplier 315.

The first multiplier 313 relating to one embodiment of this invention multiplies the first coefficient that is a waveform shifting coefficient from the waveform shifting coefficient generator 311 and the waveform signal for the continuous turn-on driving for each phase from the continuous turn-on driving waveform generator 312. As depicted in FIG. 12, the first coefficient is always zero when the vehicle speed V of the motor-assisted bicycle 1 is less than Vt′ (the frequency f is less than ft′), therefore, in a range of V<Vt′ (in a range of f<ft′), the output level from the first multiplier 313 is always zero. On the other hand, because, in a range in which V is equal to or greater than Vt′ and is less than Vt (f is equal to or greater than ft′ and is less than ft), the first coefficient between 0 and 1, which corresponds to the vehicle speed V of the motor-assisted bicycle 1 (the frequency f of the driving voltage of the motor 105), is outputted from the waveform shifting coefficient generator 311, the voltage signal obtained by multiplying the first coefficient by the PWM signal for the continuous turn-on driving from the continuous turn-on driving signal generator 312 is outputted to the signal adder 316. In a range in which V is equal to or greater than Vt (f is equal to or greater than ft), the first coefficient is always 1. Therefore, the first multiplier 313 outputs the PWM signal for the continuous turn-on driving from the continuous turn-on driving signal generator 312 to the signal adder 316, as it is.

The second multiplier 315 relating to one embodiment of this invention multiplies the second coefficient that is a value obtained by subtracting the first coefficient that is the waveform shifting coefficient from the waveform shifting coefficient generator 311, from 1 (e.g. when the waveform shifting coefficient is 0.3, the second coefficient is 0.7 (=1-0.3)) and the waveform signal for the intermittent turn-on driving for each phase from the constant level generator 314 for the intermittent turn-on driving waveform. In a range of V<Vt′ (in a range of f<ft′), the output level from the first multiplier 313 is always zero, and the second multiplier 315 outputs the waveform signal for the intermittent turn-on driving from the constant level generator 314 for the intermittent turn-on driving waveform to the signal adder 316 as it is. On the other hand, in a range in which V is equal to or greater than Vt′ and is less than Vt (f is equal to or greater than ft′ and is less than ft), the waveform shifting coefficient, which is between 0 and 1 and corresponds to the vehicle speed V of the motor-assisted bicycle 1 (frequency f), is outputted from the waveform shifting coefficient generator 311. Therefore, the signal level obtained by multiplying the waveform signal for the intermittent turn-on driving from the constant level generator 314 for the intermittent turn-on driving waveform by the second coefficient is outputted to the signal adder 316. When V is equal to or greater than Vt (f is equal to or greater than ft), the second coefficient is always 0. Therefore, the signal level outputted to the signal adder 316 from the second multiplier 315 is always 0 in the range in which V is equal to or greater than Vt (f is equal to or greater than ft).

The signal adder 316 relating to one embodiment of this invention generates a driving waveform signal for each phase by adding the output waveform for each phase from the first multiplier 313 and the output waveform for the corresponding phase from the second multiplier 315, and outputs the generated driving waveform signal to the effective driving voltage multiplier 150. The output of the effective driving voltage multiplier 150 is converted to a binary PWM signal by the PWM modulator 160. The driving signal output unit 115 generates the PWM driving signal by controlling ON and OFF of the driving waveform signal for each phase from the PWM modulator 160 with the expanded turn-on angle control signal for the corresponding phase from the turn-on angle expansion unit 113, and outputs the generated PWM driving signal to the FETs for each phase in the inverter circuit 170.

Thus, according to this embodiment, the driving waveform generator 114′ generates the driving waveform to be inputted to the effective driving voltage multiplier 150 by using not only the waveform signal for the continuous turn-on driving but also the constant level waveform signal for the intermittent turn-on driving. Especially, when the vehicle speed of the motor-assisted bicycle 1 is low, the motor 105 is driven by the waveform signal for the intermittent turn-on driving by the rectangular wave driving voltage. Therefore, even when the accuracy of the phase detection for the sine wave driving drops, it is possible to derive the torque of the motor 105 to the maximum. In addition, when the vehicle speed of the motor-assisted bicycle 1 increases, the weight of the waveform signal for the continuous driving becomes greater in the driving signal, and when shifting to the continuous turn-on driving (i.e. the vehicle speed V is Vt), the motor 105 is driven by the waveform signal for the continuous turn-on driving. Therefore, it is possible to smoothly shift to the continuous turn-on driving from the intermittent turn-on driving.

Although the embodiments of this invention were explained above, this invention is not limited to those. There are plural specific calculation methods to realize the aforementioned functions, and any one of methods may be employed. In addition, at least a part of functions realized in the driving controller 110, 210 or 310 may be implemented by a dedicated circuit, and the aforementioned functions may be realized by executing, by a computer processor, programs.

Even when it was explained that the processing or procedure explained in this specification is executed by a single apparatus or single program, the processing or procedure may be executed by plural apparatuses or plural programs. The functional blocks explained in this specification may be explained by integrating them into less functional blocks, or dividing them into more functional blocks. For example, in the embodiment depicted in FIG. 2, the expanded turn-on angle is determined by expanding the reference turn-on angle in the turn-on angle control signal generated by the turn-on angle control signal generator 111 by the expansion width determined by the monostable multivibrator output signal generated by the monostable multivibrator circuit (the turn-on angle expansion width determination unit 112). However, the calculation method of this expanded turn-on angle is a mere example, and the expanded turn-on angle may be determined by other various methods. For example, it is possible to determine the expanded turn-on angle or the expanded turn-on angle control signal by executing, by a computer processor, a software program for calculating the expanded turn-on angle based on the hall output signals and other input signals.

A motor driving control apparatus relating to one embodiment of this invention relates to a motor driving control apparatus to drive a brushless motor. The motor driving control apparatus relating to one embodiment of this invention includes an inverter circuit configured to supply a driving voltage to the brushless motor by controlling ON and OFF of switching elements, a turn-on angle controller configured to set a turn-on angle so that the turn-on angle increases according to a frequency of the driving voltage, and a driving controller configured to drive the brushless motor by outputting a driving signal of the turn-on angle set by the turn-on angle controller to the inverter circuit.

According to the motor driving control apparatus in the embodiment, because the turn-on angle increases according to the frequency of the driving voltage supplied to the brushless motor until the turn-on angle reaches 180 degrees, it is possible to perform the driving control by the intermittent driving method in which the turn-on angle is low at the low-speed rotation of the brushless motor, and it is also possible to continuously switch the driving method to the continuous turn-on driving method in which the turn-on angle is 180 degrees, when the rotation speed of the brushless motor increases. Therefore, the motor driving control apparatus can perform the driving control of the motor by switching between the intermittent turn-on driving method and the continuous turn-on driving method according to the rotation speed of the brushless motor, and also can suppress the occurrence of the vibration and/or noise at the switching, because no sudden step occurs in the driving voltage waveform before and after the switching. In addition, it is possible to maintain the best driving efficiency in each driving condition from low speed to high speed.

In one embodiment of this invention, the turn-on angle becomes 180 degrees (i.e. continuous turn-on) when the frequency of the driving voltage is the continuous turn-on shifting frequency ft. According to this embodiment, by appropriately setting the continuous turn-on shifting frequency ft according to the characteristic of the brushless motor to be driven, it is possible to prevent the deterioration of the efficiency due to the insufficiency of the rotation speed.

The motor driving control apparatus relating to one embodiment of this invention further includes a continuous turn-on driving waveform generator configured to generate a continuous turn-on driving waveform signal for driving the brushless motor by the continuous turn-on. This continuous turn-on driving waveform signal may be converted into a PWM signal by which the driving voltage from the inverter circuit becomes a sine waveform. The driving controller relating to one embodiment of this invention outputs a PWM signal for the continuous turn-on driving with the turn-on angle set by the turn-on angle controller, as the driving signal.

According to the embodiment, even when the turn-on angle is less than 180 degrees and the intermittent turn-on driving is performed, the PWM signal for the continuous turn-on driving waveform signal is outputted to the inverter circuit as the driving signal. Thus, by always using the PWM signal for the continuous turn-on driving as the driving signal of the inverter circuit, the driving voltage waveforms before and after the switching from the intermittent turn-on driving method to the continuous turn-on driving method does not greatly vary. Therefore, it is possible to decrease the fluctuation of the output torque of the motor at the switching from the intermittent turn-on driving method to the continuous turn-on driving method and suppress the occurrence of the vibration and/or noise.

The turn-on angle controller relating to one embodiment of this invention includes a turn-on angle expansion unit configured to set the turn-on angle by expanding, by a predetermined time, a reference turn-on angle that is less than 180 degrees and is triggered by each edge of the hall output signal from the brushless motor. The turn-on angle controller relating to one embodiment of this invention includes a monostable multivibrator processing unit configured to output a monostable multivibrator output signal by a predetermined output time from each edge of the hall output signal from the brushless motor. The turn-on angle expansion unit relating to one embodiment of this invention sets the turn-on angle by prolonging, by an electrical angle corresponding to the output time of the monostable multivibrator output signal, the reference turn-on angle. According to the embodiment, only by generating the monostable multivibrator output signal with a predetermined pulse width from the edge of the hall output signal, the expansion width of the reference turn-on angle can be set.

The monostable multivibrator processing unit relating to one embodiment of this invention can generate the monostable multivibrator output signal by retriggerable monostable multivibrator processing. The monostable multivibrator performs the retriggerable monostable multivibrator processing so as not to overlook a trigger of a next phase while the speed further increases more than the speed at which the driving shifts to the continuous driving and the monostable multivibrator output continues, and so as to expand the monostable multivibrator output signal from the timing of that trigger again. In addition, when the brushless motor has plural hall effect elements, it is possible to expand the reference turn-on angle by generating an individual monostable multivibrator output signal every receipt of the hall output signal.

In one embodiment of this invention, the output time of the monostable multivibrator output signal is represented by a following expression:

The monostable multivibrator output time=(1/ft)*(180−reference turn-on angle)/360

By setting the output time of the monostable multivibrator output signal like the aforementioned expression, the reference turn-on angle when the frequency of the driving voltage is f is expanded only by an electrical angle of (f/ft)*(180−the reference turn-on angle) degrees. For example, when the reference turn-on angle is 120 degrees, the expanded electrical angle of the reference turn-on angle becomes (f/ft)*60 degrees. Therefore, the reference turn-on angle is expanded by the electrical angle that is proportional to the frequency f. The expansion width (which is converted into the electrical angle) is less than 60 degrees, when the frequency of the driving voltage is less than ft, and becomes 60 degrees when the frequency of the driving voltage is ft. When the expansion width (which is converted into the electrical angle) becomes 60 degrees, the expanded turn-on angle becomes 180 degrees, and the driving is shifted to the continuous turn-on driving.

The turn-on angle controller relating to one embodiment of this invention includes: a phase detector configured to detect the edge of the hall output signal from the brushless motor and generate a lower-level phase interpolation signal that has a sawtooth wave form by interpolating the phase between the edges; a triangular wave generator configured to generate a triangular wave signal that has a predetermined amplitude by the absolute value of the lower-level phase interpolation signal; and a turn-on angle expansion coefficient calculation unit configured to calculate a turn-on angle expansion coefficient corresponding to the frequency of the driving voltage determined by the hall output signal, based on the turn-on angle expansion function. This turn-on angle expansion function is a function that determines a relationship between a reciprocal of the frequency of the driving voltage and the turn-on angle expansion coefficient, and the relationship between the reciprocal of the frequency of the driving voltage and the turn-on angle expansion coefficient is determined so that the turn-on angle expansion coefficient at which the frequency of the driving voltage is the continuous turn-on shifting frequency ft becomes equal to the amplitude of the triangular wave signal, and when the frequency of the driving voltage is less than ft, the turn-on angle expansion coefficient becomes less, when the frequency increases. In addition, the turn-on angle expansion unit relating to one embodiment of this invention expands the reference turn-on angle in an electrical angle range in which the turn-on angle expansion coefficient calculated by the turn-on angle expansion coefficient calculation unit is greater than the amplitude of the triangular wave signal.

According to the embodiment, by utilizing the triangular wave obtained by interpolating the phase between the edges of the hall output signal, the reference turn-on angle can be expanded. At this time, by adjusting the phase of the reference turn-on angle and the phase of the triangular wave and/or the symmetry of the triangular wave before and after the top of the triangular wave, it is possible to expand the turn-on angle in a forward direction, a backward direction and both directions of the reference turn-on angle.

In one embodiment of this invention, the turn-on angle expansion function determines the relationship between the reciprocal of the frequency of the driving voltage and the turn-on angle expansion coefficient so that the turn-on angle expansion coefficient becomes zero at a threshold frequency ft′ that is less than the continuous turn-on shifting frequency ft. At the low-speed rotation of the brushless motor, the relative nonuniformity of the periods among the hall periods becomes greater, the accuracy of the phase interpolation is low, and the detection accuracy of the phase is deteriorated because the voltage level becomes low even when the phase is detected by using the voltage waveform and/or the current waveform. Therefore, there is a risk that the efficiency reversely deteriorates, when expanding the reference turn-on angle based on the phase signal that has such low accuracy. According to the embodiment, at the low-speed rotation in which the frequency of the driving voltage is less than the threshold frequency ft′, the control to expand the reference turn-angle is not performed. Therefore, it is possible to prevent the deterioration of the efficiency, which is caused by the phase detection processing with the low accuracy.

What is claimed is:

1. A motor driving control apparatus for driving a brushless motor, comprising:
a turn-on controller configured to generate a first signal for controlling turn-on to the brushless motor;
a Pulse Width Modulation (PWM) signal generator configured to generate a PWM signal for driving the brushless motor by continuous turn-on with a sine wave; and
an inverter circuit configured to supply a driving voltage generated based on the first signal and the PWM signal for the brushless motor,
wherein the turn-on controller is configured to generate the first signal so that a turn-on section represented by the first signal continuously increases from a reference turn-on angle that is less than 180 degrees in accordance with increase of a rotation speed of the brushless motor, and the turn-on section of an angle corresponding to the continuous turn-on is kept when the rotation speed is equal to or greater than a predetermined speed, and
the PWM signal generator is configured to output the PWM signal in a rotation speed range including a rotation speed at which the turn-on section begins to increase from the reference turn-on angle and more.

2. The motor driving control apparatus as set forth in claim 1, wherein the turn-on controller is configured to generate, by a monostable multivibrator, the first signal from the reference turn-on angle by extending a constant period from the reference turn-on angle.

3. The motor driving control apparatus as set forth in claim 1, further comprising:
a phase detector configured to generate a second signal representing a rotation phase of a rotor in the brushless motor,
wherein the turn-on controller is configured to generate the first signal representing the turn-on section identified by a turn-on start phase and a turn-on end phase, which are based on the second signal and the rotation speed.

4. The motor driving control apparatus as set forth in claim 3, wherein the phase detector is configured to generate the second signal by detecting switching of driving phases in a third signal representing switching of driving phases in the brushless motor from a sensor that outputs the third signal, and interpolating an interval between the switchings of the driving phases.

5. The motor driving control apparatus as set forth in claim 4, wherein the turn-on controller is configured to expand the turn-on section in both of a forward direction and a backward direction when the rotation speed increases.

6. The motor driving control apparatus as set forth in claim 1, wherein the turn-on section is kept at the reference turn-on angle when the rotation speed is less than the rotation speed at which the turn-on section begins to increase from the reference turn-on angle.

7. A motor driving control apparatus for driving a brushless motor, comprising:
a turn-on controller configured to generate a first signal for controlling turn-on to the brushless motor;
a Pulse Width Modulation (PWM) signal generator configured to generate a PWM signal for driving the brushless motor; and
an inverter circuit configured to supply a driving voltage generated based on the first signal and the PWM signal for the brushless motor,
wherein the turn-on controller is configured to generate the first signal so that a turn-on section represented by the first signal continuously increases from a reference turn-on angle that is less than 180 degrees in accordance with increase of a rotation speed of the brushless motor, and the turn-on section of an angle corresponding to the continuous turn-on is kept when the rotation speed is equal to or greater than a predetermined speed, and
the PWM signal generator comprises:
a first generator configured to generate a first waveform for driving the brushless motor by continuous turn-on with a sine wave;
a waveform mixer configured to generate a driving waveform by mixing a direct current waveform having a constant level for intermittent turn-on driving with a rectangular wave and the first waveform with mixing ratios that correspond to the rotation speed; and
a second generator configured to generate the PWM signal based on the driving waveform, and
the waveform mixer is configured to increase the mixing ratio of the first waveform when the rotation speed increases, and is further configured to set 100% as the mixing ratio of the first waveform when the rotation speed is equal to or greater than the predetermined speed.
